(19) United States
(12) Patent Application Publication
(10) Pub. No.: US 2025/0192384 A1
(43) Pub. Date: Jun. 12, 2025

(54) APPARATUS FOR MANUFACTURING SECONDARY BATTERY

(71) Applicant: LG ENERGY SOLUTION, LTD., Seoul (KR)

(72) Inventors: In Jae SEO, Daejeon (KR); Bae Hong MIN, Daejeon (KR)

(73) Assignee: LG ENERGY SOLUTION, LTD., Seoul (KR)

(21) Appl. No.: 18/843,057

(22) PCT Filed: Apr. 14, 2023
(86) PCT No.: PCT/KR2023/005102

§ 371 Date: Aug. 30, 2024

(30) Foreign Application Priority Data
Apr. 15, 2022 (KR) 10-2022-0047095

(51) Int. Cl. H01M 50/533

(52) U.S. Cl. CPC H01M 50/533

(57) ABSTRACT

Discussed is an apparatus for manufacturing a secondary battery including: a main body; and at least one bending jig that is connected to the main body and presses and molds an electrode lead of the secondary battery, wherein the at least one bending jig includes a coupling part coupled to the main body, and a bending part provided at one side of the coupling part and having at least one surface provided to be inclined.

### CROSS-REFERENCE TO RELATED APPLICATION

The present application claims the benefit of the priority of Korean Patent Application No. 10-2022-0047095, filed on Apr. 15, 2022, which is hereby incorporated by reference in its entirety.

### TECHNICAL FIELD

The present invention relates to an apparatus for manufacturing a secondary battery, and more particularly, to an apparatus for manufacturing a secondary battery, which molds an electrode lead of the secondary battery.

### BACKGROUND ART

Recently, secondary batteries are widely used not only in small-sized devices such as portable electronic devices, but also in medium to large-sized devices such as vehicles or power storage systems. When the secondary batteries are used in these medium to large-sized devices, a secondary battery module in which multiple secondary batteries are electrically connected to each other to increase capacity and output is mostly used.

In general, the electrical connection between the secondary batteries in the secondary battery module is provided in such a manner that a plurality of electrode leads are welded to a busbar made of a conductive material. In more detail, referring to FIG. 1A, an electrical connection between secondary batteries 10 is provided by bending one end of an electrode lead 12, which protrudes from a battery case 11 in which an electrode assembly is embedded, by using a bending jig 30 to dispose the end on a busbar 20 and then, emitting a laser onto an overlapping portion of the electrode lead 12 and the busbar 20 to perform overlap welding so that the electrode lead 12 is fixed to the busbar 20.

However, as the electrode lead 12 generally has a shape of a thin and flat plate and is made of a material such as copper or aluminum, there is a problem that, in a process of transferring the secondary batteries 10, the end of the electrode lead 12 is often bent as illustrated in FIG. 1B.

In this case, as illustrated in FIG. 1C, the bending jig 30 and the electrode lead 12 interfere with each other to cause problems that the electrode lead 12 is damaged or the electrode lead 12 is insufficiently bent toward the busbar 20. These problems lead to a welding defect, which reduces quality of products and increases manufacturing costs.

Accordingly, there is a need for technical development to solve the problems above.

### DISCLOSURE OF THE INVENTION

### Technical Problem

The present invention has been devised to solve the problems as above, and an object of the present invention is to provide an apparatus for manufacturing a secondary battery, which is capable of easily bending an electrode lead even in a situation in which the electrode lead has been bent.

### Technical Solution

The present invention provides an apparatus for manufacturing a secondary battery, the apparatus including: a main body; and at least one bending jig that is connected to the main body and presses and molds an electrode lead of the secondary battery, wherein the at least one bending jig includes a coupling part coupled to the main body, and a bending part provided at one side of the coupling part and having at least one surface provided to be inclined.

In the bending part, the at least one surface may be provided to be inclined in a direction away away from the coupling part.

The bending part may include a pair of inclined surfaces, each of which is provided to be inclined in a direction away from the coupling part, and a pressing surface which is provided between the pair of inclined surfaces and presses the electrode lead.

Each of the pair of inclined surfaces may be further provided to be inclined in a direction away from the pressing surface.

Each of the pair of inclined surfaces may be respectively provided on a corner of a surface facing the electrode lead.

Each of the pair of inclined surfaces may have a width that gradually decreases in a direction closer to the coupling part.

The pressing surface may have a width that gradually increases in a direction closer to the coupling part.

Each of the pair of inclined surfaces may have a maximum length that is less than or equal to approximately ⅘ of a length of the bending part.

Each of the pair of inclined surfaces may have a maximum width that is less than or equal to approximately ½ of a width of the bending part.

Each of the pair of inclined surfaces may have a tilt angle of approximately 4 degrees to 5 degrees.

In the bending part, one side surface and another side surface disposed in a direction opposite to the one side surface may be provided to be inclined.

The at least one bending jig may further include a connecting part that connects the coupling part and the bending part to each other between the coupling part and the bending part.

The connecting part may be bent to be connected to each of the coupling part and the bending part.

The coupling part, the connecting part, and the bending part may be provided as one body.

The at least one bending jig may be provided in a pair that face each other on one side of the main body.

The bending part may include an inner side and an outer side opposite to the inner side, and each of the inner side and the outer side may include a pair of inclined surfaces constituting the at least one surface provided to be inclined, and a pressing surface interposed between the pair of inclined surfaces to separate the pair of inclined surfaces.

### Advantageous Effects

According to the present invention, the at least one surface of the bending jig may be provided to be inclined so that the electrode lead is easily bent even in the situation in which the electrode lead has been bent. Accordingly, the present invention has the effects that the defect rate of the secondary batteries may be reduced to save the processing costs for the defects and improve the yield of the secondary batteries.

### BRIEF DESCRIPTION OF THE DRAWINGS

FIG. 1A is a conceptual view illustrating a state in which an electrode lead is bent using a pressing jig according a related art.

FIG. 1B is a conceptual view illustrating a state in which a pressing jig moves toward a bent electrode lead according to the related art.

FIG. 1C is a conceptual view illustrating a state in which a pressing jig interferes with a bent electrode lead according to the related art.

FIG. 2 is a perspective view illustrating an apparatus for manufacturing a secondary battery according to Embodiment 1 of the present invention.

FIG. 3 is a plan view of the apparatus for manufacturing the secondary battery in FIG. 2.

FIG. 4 is a perspective view more specifically illustrating a bending jig in the apparatus for manufacturing the secondary battery in FIG. 2.

FIG. 5 is a plan view more specifically illustrating the bending jig in the apparatus for manufacturing the secondary battery in FIG. 2.

FIG. 6 is a side view more specifically illustrating the bending jig in the apparatus for manufacturing the secondary battery in FIG. 2.

FIG. 7 is a front view of the apparatus for manufacturing the secondary battery in FIG. 2.

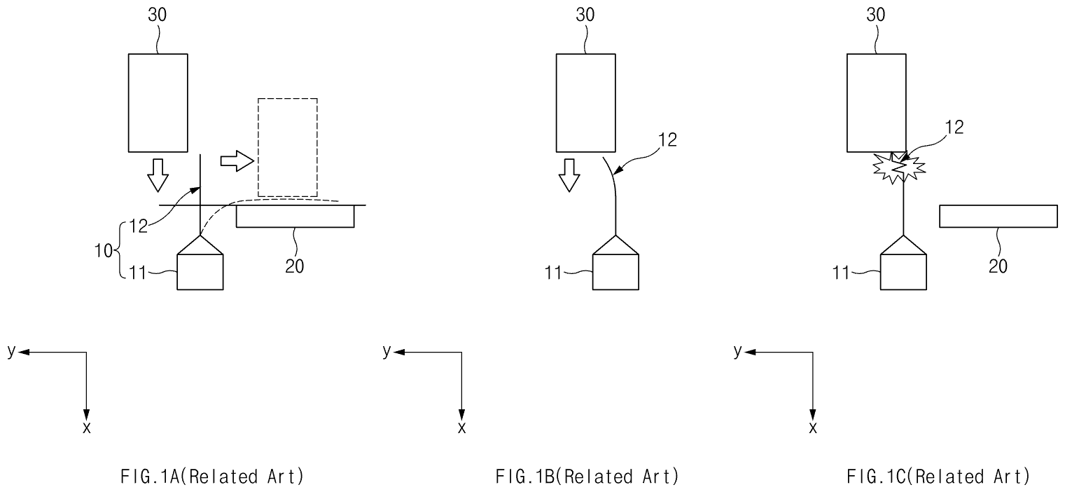

### MODE FOR CARRYING OUT THE INVENTION

Hereinafter, preferred embodiments of the present invention will be described in detail with reference to the accompanying drawings to enable those skilled in the art to which the present invention pertains to easily carry out the present invention. The present invention may, however, be embodied in different forms and should not be construed as limited by the embodiments set forth herein.

The parts unrelated to the description, or the detailed descriptions of related well-known art that may unnecessarily obscure subject matters of the present invention, will be ruled out in order to clearly describe the present invention. Like reference numerals refer to like elements throughout the whole specification.

Moreover, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Apparatus for Manufacturing Secondary Battery

The present invention provides an apparatus 100 for manufacturing a secondary battery 10. The apparatus 100 includes a main body 110 and at least one bending jig 120, which is connected to the main body 110 and presses and molds an electrode lead 12 of the secondary battery 10, and the bending jig 120 includes a coupling part 121 coupled to the main body 110, and a bending part 122 provided at one side of the coupling part 121 and having at least one surface provided to be inclined.

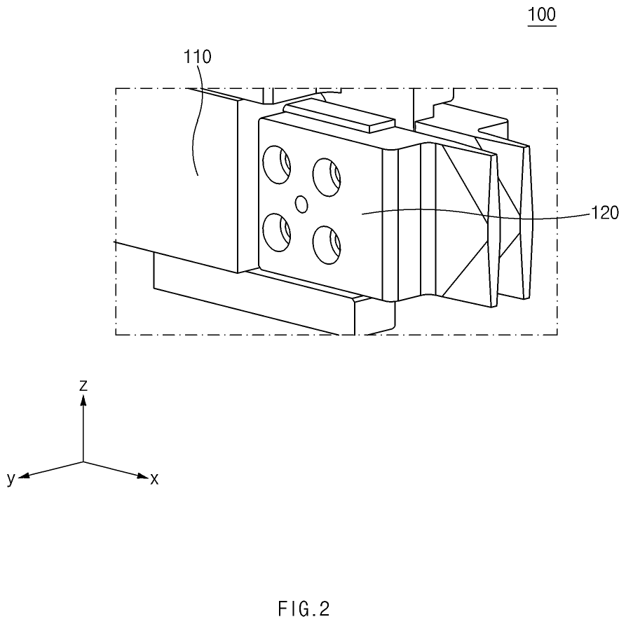

Here, the main body 110 is a component that supports the bending jig 120 as illustrated in FIG. 2, and may have various configurations. For example, the main body 110 may include a driving device such as an actuator, so that the bending jig 120 is movable with respect to the electrode lead 12.

The bending jig 120 is a component, which is connected to the main body 110 and presses and molds the electrode lead 12 of the secondary battery 10, and may have various configurations.

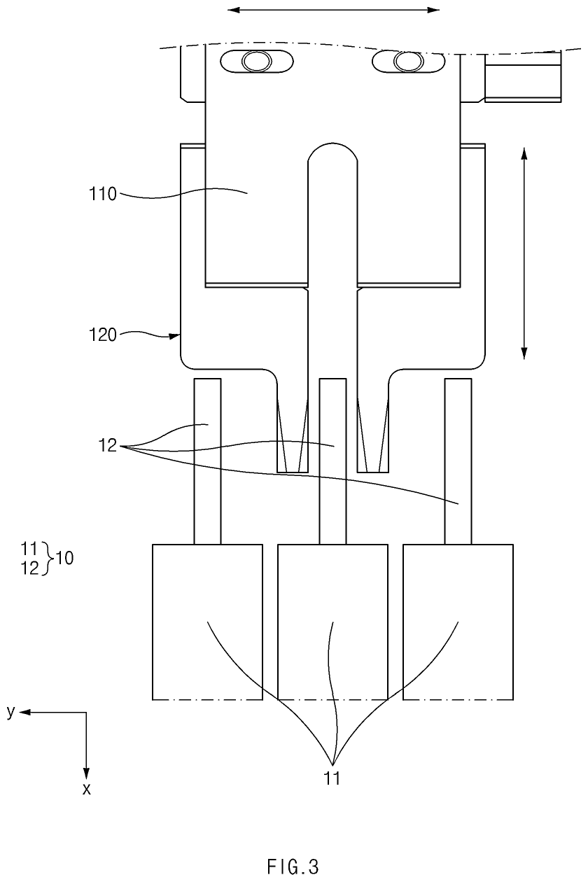

Specifically, as illustrated in FIG. 3, the bending jig 120 may be provided to be movable with respect to the electrode lead 12 so as to press and mold the electrode lead 12 of the secondary battery 10. Here, the bending jig 120 may be provided to be movable from the main body 110, and may be provided to move integrally with the main body 110.

In more detail, the bending jig 120 may move in a direction, which is parallel to an X direction in FIG. 3, to approach the electrode lead 12 protruding from a battery case 11, and move in a direction, which is parallel to a Y direction in FIG. 3, to press and bend the electrode lead 12.

This bending jig 120 may be provided in one or more at one side of the main body 110. For example, the bending jig 120 may be provided in a pair that face each other at the one side of the main body 110. In this case, the electrode lead 12 may be inserted between the bending jigs 120 facing each other.

Meanwhile, a structure of the bending jig 120 is specifically described below.

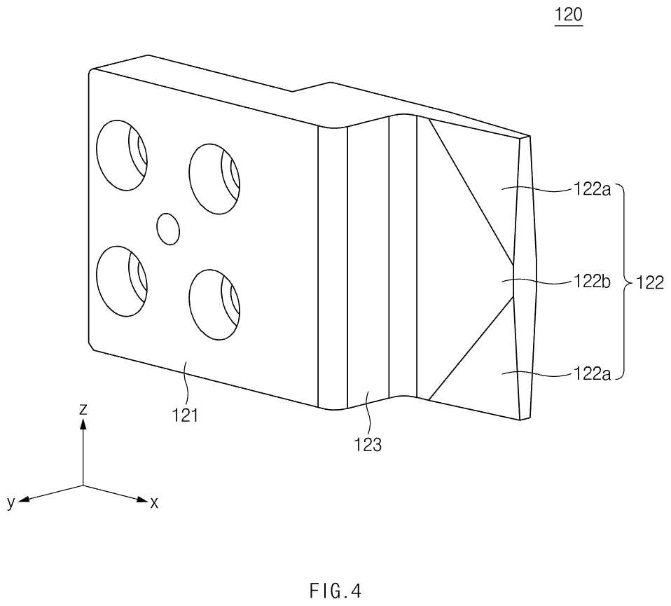

As illustrated in FIG. 4, the bending jig 120 according to the present invention may include the coupling part 121 coupled to the main body 110, and the bending part 122 provided at one side of the coupling part 121 and having at least one surface provided to be inclined.

Here, the coupling part 121 is a component coupled to the main body 110, and may be coupled to the main body 110 in various methods. For example, the coupling part 121 may be coupled to the main body 110 through bolt-coupling or the like.

Meanwhile, the bending part 122 may be provided at one side of the coupling part 121 and have at least one surface provided to be inclined. In more detail, in the bending part 122, at least a portion of a surface provided to face the electrode lead 12 may be provided to be inclined downward as being far away from the coupling part 121.

Accordingly, even though the electrode lead 12 has been bent when the bending jig 120 approaches the electrode lead 12, the bending part 122 may guide movement of the electrode lead 12 so that an end of the electrode lead 12 is seated on the inclined surface of the bending part 122 and then, moves slowly in the inclined direction.

Accordingly, the bending part 122 may prevent damage to the electrode lead 12, and may bend and mold the bent electrode lead 12, like the electrode lead 12 having a flat shape that is not bent.

This bending part 122 may have various structures.

For example, considering that a cross section of the electrode lead 12 is deformed to have a “U” shape as a corner of the end of the electrode lead 12 is bent, the bending part 122 may include a pair of inclined surfaces 122a, each of which is provided to be inclined downward as being away from the coupling part 121, and a pressing surface 122b that is provided between the pair of inclined surfaces 122a and presses the electrode lead 12. In this case, the inclined surface 122a and the pressing surface 122b may be provided on a surface of the bending part 122 facing the electrode lead 12.

In more detail, the inclined surface 122a may be provided on a corner of the surface facing the electrode lead 12. The inclined surface 122a may be provided to be inclined downward as being away from the pressing surface 122b.

The pressing surface 122b may be provided at a center of the surface, which faces the electrode lead 12, between the pair of inclined surfaces 122a. The pressing surface 122b may have a uniform height regardless of a distance between the pressing surface 122b and the coupling part 121, so as to uniformly press one surface of the electrode lead 12 generally having shape of a flat plate. Accordingly, the pressing surface 122b may be provided to be parallel to the one surface of the electrode lead 12.

Even when the end of the electrode lead 12 has been bent, the bending jig 120 having this structure may allow the electrode lead 12 to be in first contact with the inclined surface 122a and slowly move along the inclined surface 122a according to the movement of the bending jig 120, and the electrode lead 12 may reach the pressing surface 122b to be pressed. Accordingly, the electrode lead 12 may be molded to be bent without being damaged.

Meanwhile, in the inclined surface 122a and the pressing surface 122b described above, as illustrated in FIG. 4, a width of the inclined surface 122a may gradually decrease as being close to the coupling part 121, and a width of the pressing surface 122b may gradually increase as being close to the coupling part 121, so that the electrode lead 12 reaches the pressing surface 122b through the inclined surface 122a according to the movement of the bending jig 120.

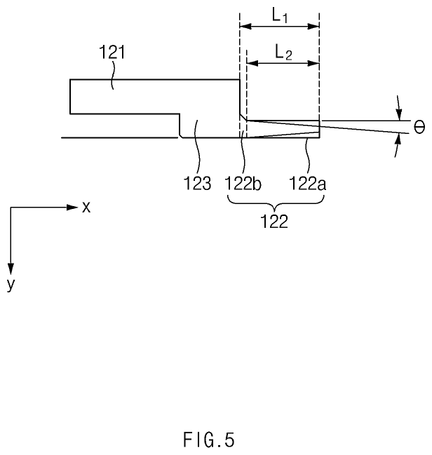

As illustrated in FIG. 5, the inclined surface 122a may have various tilt angles θ on the bending part 122. However, there are problems that, when the tilt angle θ is less than 4 degrees, the inclined surface 122a is less effective in guiding the electrode lead 12 without damage when the electrode lead 12 has been bent, and when the tilt angle e is greater than 5 degrees, the electrode lead 12 is difficult to sufficiently press due to a large loss area of the bending part 122. Preferably, considering these problems, the inclined surface 122 may have the tilt angle θ of 4 degrees to 5 degrees. For example, the inclined surface 122 may have the tilt angle θ of 4.3 degrees.

In addition, as illustrated in FIG. 5, the inclined surface 122a may have various lengths on the bending part 122. However, there is a problem that, when the maximum length L₂ of the inclined surface 122a is greater than ⅘ a length L₁ of the bending part 122, the electrode lead 12 is difficult to sufficiently press due to a large loss area of the bending part 122. Preferably, considering this problem, the maximum length L₂ of the inclined surface 122a may be provided to be less than or equal to ⅘ the length L₁ of the bending part 122. Here, the length of each of the inclined surface 122a and the bending part 122 may be understood as a length provided in an X direction in FIG. 5.

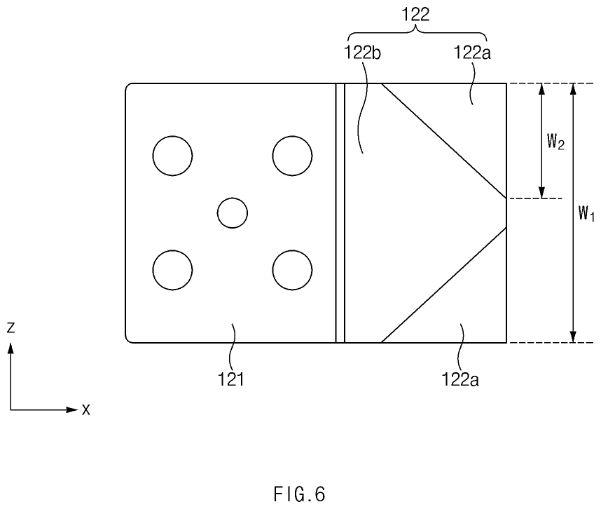

Furthermore, as illustrated in FIG. 6, the inclined surface 122a may have various widths on the bending part 122. Preferably, here, when the inclined surface 122a is provided in a pair on each of corners of the surface, which faces the electrode lead 12, of the bending part 122, the maximum width W₂ of the inclined surface 122a may be provided to be less than or equal to ½ a width W₁ of the bending part 122. Here, the width of each of the inclined surface 122a and the bending part 122 may be understood as a length provided in a Z direction in FIG. 6.

Meanwhile, the bending part 122 having the characteristics described above may have a structure in which one side surface and the other side surface disposed in a direction opposite to the one side surface are provided to be inclined. In this case, even though the electrode lead 12 having a bending shape is disposed to face any surface of the one side surface and the other side surface of the bending part 122, only the moving direction of the bending jig 120 may be controlled to easily press and bend the electrode lead 12.

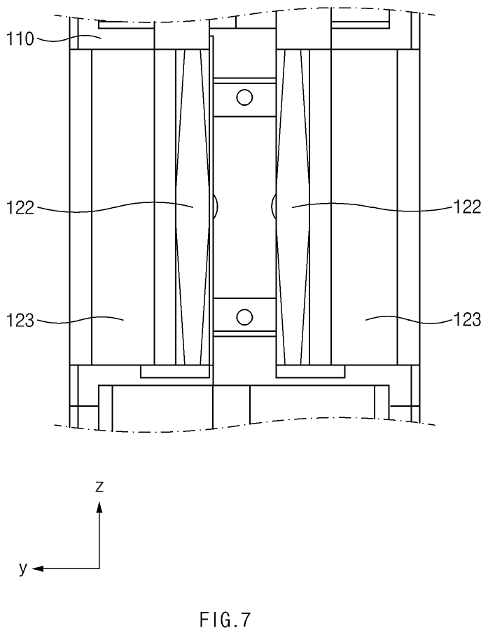

For example, the bending part 122 may have one side surface, on which the pair of inclined surfaces 122a and the pressing surface 122b that are described above are provided, and the other side surface on which the pair of inclined surfaces 122a and the pressing surface 122b are also provided. Here, the one side surface and the other side surface may be understood as surfaces provided to be perpendicular to a Y direction in FIG. 7.

In this case, the bending part 122 may have a cross section (cross section of a Y-Z plane in FIG. 7) having an octagonal shape as illustrated in FIG. 7. However, the shape of the cross section of the bending part 122 is not limited thereto, and the cross section may also have various shapes such as a hexagonal shape or a rectangular shape, according to the shape and the position of the inclined surface 122a.

Meanwhile, the bending jig 30 may further include a connecting part 123 that connects the coupling part 121 and the bending part 122 to each other between the coupling part 121 and the bending part 122.

Here, the connecting part 123 may be bent to be connected to each of the coupling part 121 and the bending part 122. Specifically, the connecting part 123 may have one end, which is bent to be connected to the coupling part 121, and the other end which is bent to be connected to the bending part 122, so as to connect the coupling part 121 and the bending part 122 to each other. For example, the connecting part 123 may be perpendicularly connected to each of the coupling part 121 and the bending part 122.

The connecting part 123 described above may be provided as one body with the coupling part 121 and the bending part 122, or may be provided as a separate component to have both ends that are connected to the coupling part 121 and the bending part 122, respectively.

Although the present invention has been described with reference to the limited embodiments and drawings, the present invention is not limited thereto and may be variously implemented by those of ordinary skill in the art to which the present invention pertains, within the technical idea of the present invention and an equivalent of the appended claims.

### DESCRIPTION OF THE SYMBOLS

10: Secondary battery
11: Battery case
12: Electrode lead
100: Apparatus for manufacturing secondary battery
110: Main body
120; Bending jig
121: Coupling part
122: Bending part
122a: Inclined surface
122b: Pressing surface
123: Connecting part
L₁: Length of bending part
L₂: Maximum length of inclined surface
W₁: Width of bending part
W₂: Maximum width of inclined surface
θ: Tilt angle

1. An apparatus for manufacturing a secondary battery, the apparatus comprising:
a main body; and
at least one bending jig connected to the main body and configured to press and mold an electrode lead of the secondary battery,
wherein the at least one bending jig comprises:
a coupling part coupled to the main body; and
a bending part provided at one side of the coupling part and having at least one surface provided to be inclined.

2. The apparatus of claim 1, wherein, in the bending part, the at least one surface is provided to be inclined in a direction away from the coupling part.

3. The apparatus of claim 1, wherein the bending part comprises:
a pair of inclined surfaces, each of which is provided to be inclined in a direction away from the coupling part; and
a pressing surface provided between the pair of inclined surfaces and configured to press the electrode lead.

4. The apparatus of claim 3, wherein each of the pair of inclined surfaces is further provided to be inclined in a direction away from the pressing surface.

5. The apparatus of claim 3, wherein each of the pair of inclined surfaces is respectively provided on a corner of a surface facing the electrode lead.

6. The apparatus of claim 3, wherein each of the pair of inclined surfaces has a width that gradually decreases in a direction closer to the coupling part.

7. The apparatus of claim 3, wherein the pressing surface has a width that gradually increases in a direction closer to the coupling part.

8. The apparatus of claim 3, wherein each of the pair of inclined surfaces has a maximum length that is less than or equal to approximately ⅘ of a length of the bending part.

9. The apparatus of claim 3, wherein each of the pair of inclined surface surfaces has a maximum width that is less than or equal to approximately ½ of a width of the bending part.

10. The apparatus of claim 3, wherein each of the pair of inclined surface surfaces has a tilt angle of approximately 4 degrees to 5 degrees.

11. The apparatus of claim 1, wherein, in the bending part, one side surface and another side surface disposed in a direction opposite to the one side surface are provided to be inclined.

12. The apparatus of claim 1, wherein the at least one bending jig further comprises a connecting part configured to connect the coupling part and the bending part to each other between the coupling part and the bending part.

13. The apparatus of claim 12, wherein the connecting part is bent to be connected to each of the coupling part and the bending part.

14. The apparatus of claim 12, wherein the coupling part, the connecting part, and the bending part are provided as one body.

15. The apparatus of claim 1, wherein the at least one bending jig is provided in a pair that face each other on one side of the main body.

16. The apparatus of claim 1, wherein the bending part includes an inner side and an outer side opposite to the inner side, and
wherein each of the inner side and the outer side includes a pair of inclined surfaces constituting the at least one surface provided to be inclined, and a pressing surface interposed between the pair of inclined surfaces to separate the pair of inclined surfaces.
